(19) United States
(12) Patent Application Publication
(10) Pub. No.: US 2020/0238293 A1
(43) Pub. Date: Jul. 30, 2020

(54) CRUSHING APPARATUS

(71) Applicant: SEIKO EPSON CORPORATION, Tokyo (JP)

(72) Inventors: Hiroki KURATA, Matsumoto (JP); Yoichi MIYASAKA, Suwa (JP)

(21) Appl. No.: 16/748,838

(22) Filed: Jan. 22, 2020

(30) Foreign Application Priority Data
Jan. 24, 2019 (JP) 2019-010193

(51) Int. Cl. B02C 18/18; B02C 18/10

(52) U.S. Cl. CPC B02C 18/18; B02C 18/10

(57) ABSTRACT

A crushing apparatus includes a first rotary shaft member, a second rotary shaft member, a plurality of first rotary cutters, a plurality of second rotary cutters, a plurality of first spacers, and a plurality of second spacers, the first rotary cutters and the first spacers being alternately disposed in a first axis direction, the second rotary cutters and the second spacers being alternately disposed in the first axis direction, the first rotary cutters and the second rotary cutters each forming a tearing blade that protrudes in a direction perpendicular to the first axis direction, a portion of each of the first rotary cutters and a portion of each of the second rotary cutters overlapping when viewed from the first axis direction, and a gap being provided between the first rotary cutter and the second rotary cutter in the first axis direction.

The present application is based on, and claims priority from JP Application Serial Number 2019-010193, filed Jan. 24, 2019, the disclosure of which is hereby incorporated by reference herein in its entirety.

### BACKGROUND

### 1. Technical Field

The present disclosure relates to a crushing apparatus.

### 2. Related Art

A crushing apparatus for crushing paper is known. For example, in JP-A-59-16552, as a crushing apparatus, there is described a document shredding machine having two rotary shafts parallel to each other, in which a large number of rotary cutters and spacers that rotate together with the respective shafts are alternately inserted into the respective shafts, and the rotary cutters of both shafts are arranged to mesh with each other.

For example, JP-A-2012-144819 describes that in a paper recycling apparatus, waste paper is divided into pieces of paper that are several centimeters square with a crushing blade of a crusher.

In the paper recycling apparatus as described above, it is desired to produce recycled paper with high paper strength. However, since the rotary cutter of the crushing apparatus described in JP-A-59-16552 has good sharpness, when the rotary cutter is used to cut paper into paper pieces, the fiber length tends to be short, and it is difficult to produce recycled paper with high paper strength.

### SUMMARY

According to an aspect of the present disclosure, a crushing apparatus includes a first rotary shaft member that rotates about a first axis, a second rotary shaft member that rotates about a second axis parallel to the first axis in an opposite direction to a direction in which the first rotary shaft member rotates, a plurality of first rotary cutters provided on the first rotary shaft member and rotating together with the first rotary shaft member, a plurality of second rotary cutters provided on the second rotary shaft member and rotating together with the second rotary shaft member, a plurality of first spacers provided on the first rotary shaft member, and a plurality of second spacers provided on the second rotary shaft member, in which the first rotary cutters and the first spacers are alternately disposed in a first axis direction, the second rotary cutters and the second spacers are alternately disposed in the first axis direction, the first rotary cutters and the second rotary cutters each form a tearing blade that protrudes in a direction perpendicular to the first axis direction, a portion of each of the first rotary cutters and a portion of each of the second rotary cutters overlap when viewed from the first axis direction, and a gap is provided between the first rotary cutter and the second rotary cutter in the first axis direction.

In the crushing apparatus according to an aspect, the first rotary cutter and the second rotary cutter may each include a first surface and a second surface that are perpendicular to the first axis direction, a third surface formed in a thickness direction of the first rotary cutter and the second rotary cutter, the tearing blade being provided on the third surface, and a ripping blade protruding in a direction intersecting the second surface between the second surface and the third surface, and a size of the gap may be larger than a size of the ripping blade in the first axis direction.

In the crushing apparatus according to an aspect, the third surface may include a protruding portion protruding in the direction perpendicular to the first axis direction, and a corner portion of the protruding portion provided on the third surface may have an obtuse angle of 90° or more, or the corner portion may be chamfered.

The crushing apparatus according to an aspect may further include a first gap-forming member provided on the first rotary shaft member and forming the gap, and a second gap-forming member provided on the second rotary shaft member and forming the gap.

### BRIEF DESCRIPTION OF THE DRAWINGS

FIG. 1 is a sectional view schematically illustrating a crushing apparatus according to a first embodiment.

FIG. 2 is a plan view schematically illustrating the crushing apparatus according to the first embodiment.

FIG. 3 is a sectional view schematically illustrating a first rotary cutter of the crushing apparatus according to the first embodiment.

FIG. 4 is a plan view schematically illustrating the first rotary cutter of the crushing apparatus according to the first embodiment.

FIG. 5 is a sectional view schematically illustrating a manufacturing process for the crushing apparatus according to the first embodiment.

FIG. 6 is a sectional view schematically illustrating the manufacturing process for the crushing apparatus according to the first embodiment.

FIG. 7 is a plan view schematically illustrating the manufacturing process for the crushing apparatus according to the first embodiment.

FIG. 8 is a sectional view schematically illustrating the manufacturing process for the crushing apparatus according to the first embodiment.

FIG. 9 is a sectional view schematically illustrating a crushing apparatus according to a second embodiment.

FIG. 10 is a sectional view schematically illustrating a first rotary cutter of the crushing apparatus according to a second embodiment.

FIG. 11 is a sectional view schematically illustrating a first rotary cutter of a crushing apparatus according to a modification of the second embodiment.

FIG. 12 is a sectional view schematically illustrating a manufacturing process for the crushing apparatus according to the modification of the second embodiment.

FIG. 13 is a photograph illustrating small pieces of Example 1.

FIG. 14 is a photograph illustrating a small piece of Comparative Example 1.

FIG. 15 is a photograph illustrating small pieces of Example 2.

FIG. 16 is a photograph illustrating small pieces of Comparative Example 2.

### DESCRIPTION OF EXEMPLARY EMBODIMENTS

Below, a preferred embodiment of the disclosure will be described with reference to the drawings. Further, the embodiments described below do not unduly limit the contents of the present disclosure described in the claims. In addition, not all of the configurations described below are essential constituent requirements of the present disclosure.

### 1. First Embodiment

### 1.1. Crushing Apparatus

### 1.1.1. Configuration

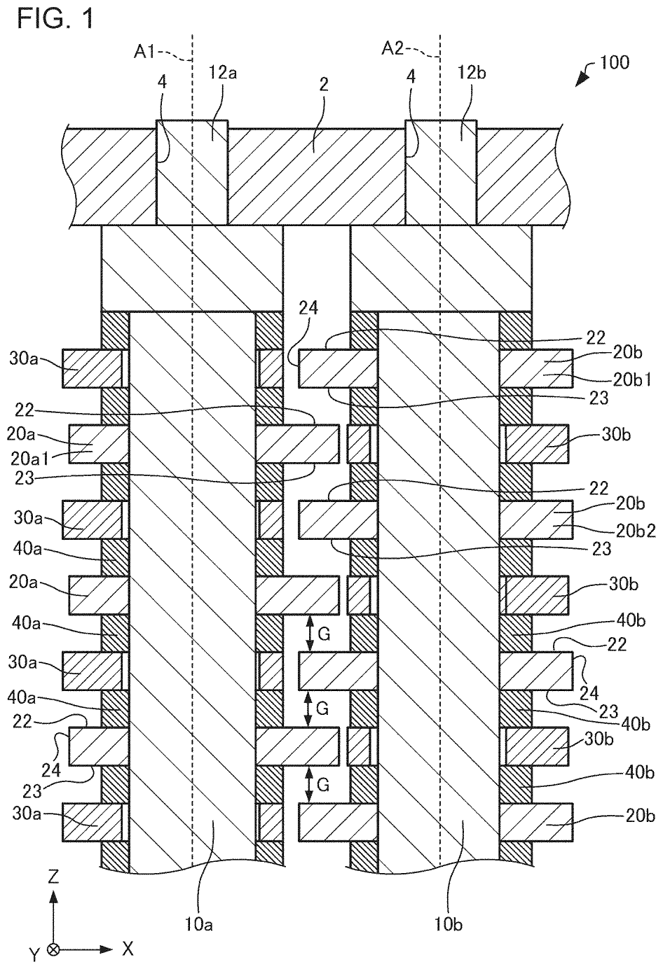

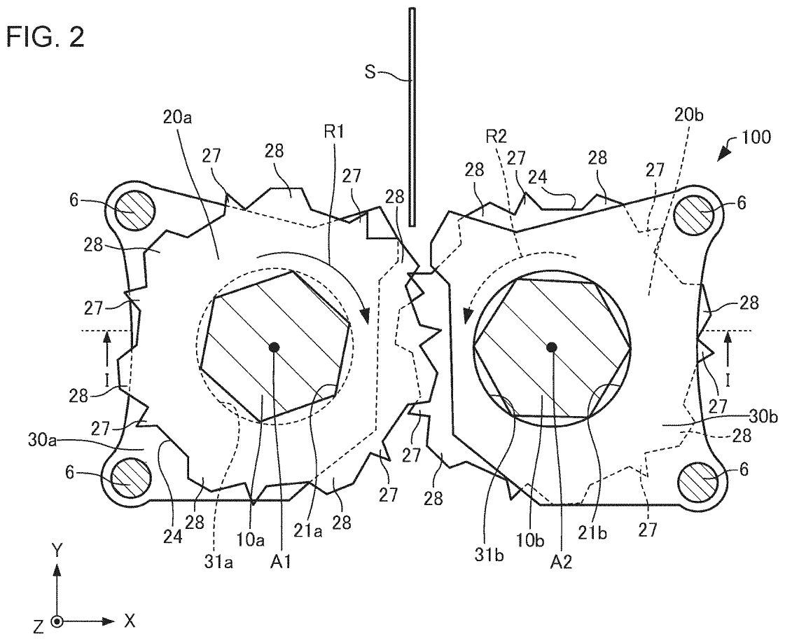

First, the crushing apparatus according to the first embodiment will be described with reference to the drawings. FIG. 1 is a sectional view schematically illustrating a crushing apparatus 100 according to the first embodiment. FIG. 2 is a plan view schematically illustrating the crushing apparatus 100 according to the first embodiment. Further, FIG. 1 is a sectional view taken along line I-I of FIG. 2. In addition, in FIGS. 1 and 2, the X axis, the Y axis, and the Z axis are illustrated as three axes perpendicular to each other.

As illustrated in FIGS. 1 and 2, the crushing apparatus 100 includes, for example, a first rotary shaft member 10a, a second rotary shaft member 10b, a first rotary cutter 20a, a second rotary cutter 20b, a first spacer 30a, a second spacer 30b, a first gap-forming member 40a, and a second gap-forming member 40b. Further, for convenience, illustration of members other than the rotary shaft members 10a and 10b, the rotary cutters 20a and 20b, and the spacers 30a and 30b is omitted in FIG. 2.

The first rotary shaft member 10a rotates about a first axis A1. The second rotary shaft member 10b rotates about a second axis A2 parallel to the first axis A1 in the opposite direction to the direction in which the first rotary shaft member 10a rotates. In the illustrated example, the first axis A1 and the second axis A2 are axes parallel to the Z axis. The first rotary shaft member 10a is located in the −X axis direction away from the second rotary shaft member 10b.

The rotary shaft members 10a and 10b are supported by a fixed frame 2. In the illustrated example, a distal end portion 12a of the first rotary shaft member 10a and a distal end portion 12b of the second rotary shaft member 10b are supported by a bearing portion 4 of the fixed frame 2 so as to rotate. The distal end portions 12a and 12b are +Z-axis direction end portions of the rotary shaft members 10a and 10b, respectively.

Further, the fixed frame 2 houses the rotary shaft members 10a and 10b, the rotary cutters 20a and 20b, the spacers 30a and 30b, and the gap-forming members 40a and 40b. Although not illustrated, the fixed frame 2 is provided with a slot for loading the sheet S to be roughly crushed.

The shape of the rotary shaft members 10a and 10b is, for example, a hexagon when viewed from the direction of the first axis A1. Further, the shape of the rotary shaft members 10a and 10b seen from the first axis A1 direction is not specifically limited, and a circle, a polygon other than a hexagon, or the like may suffice. The first axis A1 direction is a direction in which the first axis A1 extends, and is the Z-axis direction in the illustrated example.

The first rotary cutter 20a is provided on the first rotary shaft member 10a. The first rotary cutter 20a is provided in a plurality. The first rotary cutters 20a are fixed to the first rotary shaft member 10a and rotate in a direction R1 illustrated in FIG. 2 together with the first rotary shaft member 10a. The first rotary cutters 20a are each provided with, for example, a through hole 21a penetrating in the Z-axis direction, and the through hole 21a and the first rotary shaft member 10a are fitted to each other.

The second rotary cutter 20b is provided on the second rotary shaft member 10b. The second rotary cutter 20b is provided in a plurality. The second rotary cutters 20b are fixed to the second rotary shaft member 10b and rotate in a direction R2 illustrated in FIG. 2 together with the second rotary shaft member 10b. The second rotary cutters 20b are each provided with, for example, a through hole 21b penetrating in the Z-axis direction, and the through hole 21b and the second rotary shaft member 10b are fitted to each other. The material of the rotary cutters 20a and 20b is, for example, a metal.

The rotary cutters 20a and 20b are, for example, planar plate members having a thickness in the Z-axis direction. The thickness of the rotary cutters 20a and 20b is, for example, 1 mm or more and 5 mm or less, and is preferably 2 mm. The shape of the first rotary cutters 20a and the shape of the second rotary cutters 20b are, for example, the same.

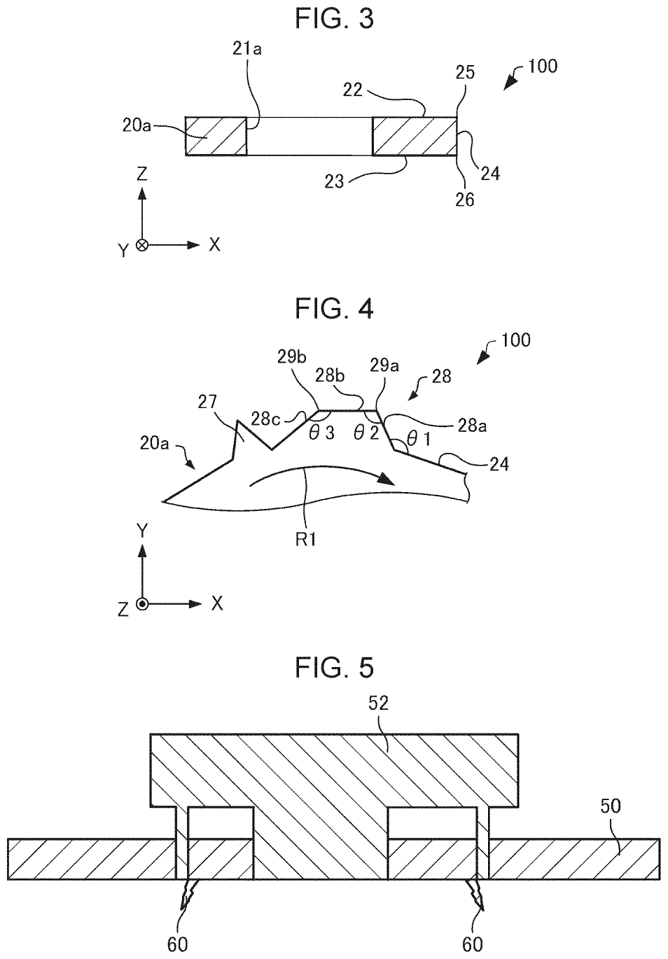

Here, FIG. 3 is a sectional view schematically illustrating the first rotary cutters 20a. The rotary cutters 20a and 20b each have a first surface 22, a second surface 23, and a third surface 24, as illustrated in FIG. 3. The first surface 22 and the second surface 23 are surfaces perpendicular to the first axis A1 direction. In the illustrated example, the surfaces 22 and 23 are surfaces parallel to the XY plane, and the first surface 22 is located in the +Z-axis direction away from the second surface 23. The third surface 24 is a surface that couples the first surface 22 and the second surface 23, and is a surface that forms the outer periphery of the rotary cutters 20a and 20b. The third surface 24 is a surface formed in the thickness direction of the rotary cutters 20a and 20b.

The rotary cutters 20a and 20b each have a corner portion 25 between the first surface 22 and the third surface 24, and a corner portion 26 between the second surface 23 and the third surface 24. The corner portion 25 is a coupling portion between the first surface 22 and the third surface 24, and is a corner portion constituted by the first surface 22 and the third surface 24. The corner portion 26 is a coupling portion between the second surface 23 and the third surface 24, and is a corner portion constituted by the second surface 23 and the third surface 24.

The rotary cutters 20a and 20b each have a tearing blade 27 as illustrated in FIG. 2. The rotary cutters 20a and 20b form the tearing blade 27. The third surface 24 forms the tearing blade 27, which protrudes in a direction perpendicular to the first axis A1 direction. The tearing blade 27 is provided on the third surface 24. The tearing blade 27 protrudes in a direction perpendicular to the first axis A1 direction from a portion of the third surface 24 that does not form the tearing blade 27 and a protruding portion 28. The shape of the tearing blade 27 is, for example, a substantially triangular shape when viewed from the Z-axis direction. The tearing blades 27 is a blade that forms, in the sheet S, slits that extend in a direction perpendicular to a loading direction of the sheet S.

The tearing blade 27 is, for example, provided in a plurality. The plurality of tearing blades 27 of the first rotary cutter 20a are provided at predetermined intervals along the rotation direction R1 of the first rotary cutter 20a. The plurality of tearing blades 27 of the second rotary cutter 20b are provided at predetermined intervals along the rotation direction R2 of the second rotary cutter 20b.

The rotary cutters 20a and 20b have the protruding portion 28. The third surface 24 forms the protruding portion 28, which protrudes in a direction perpendicular to the first axis A1 direction. The third surface 24 includes the protruding portion 28. The protruding portion 28 protrudes in a direction perpendicular to the first axis A1 direction from the portion of the third surface 24 that does not form the tearing blade 27 and the protruding portion 28.

Here, FIG. 4 is a sectional view schematically illustrating the first rotary cutter 20a. As illustrated in FIG. 4, the third surface 24 of the protruding portion 28 has, for example, a front inclined surface 28a, a planar surface 28b, and a rear inclined surface 28c. The front inclined surface 28a of the first rotary cutter 20a is a surface that rises at an obtuse angle θ1 from the portion of the third surface 24 that does not form the protruding portion 28 and that is in front of the front inclined surface 28a in the rotation direction R1 of the first rotary cutter 20a. The front inclined surface 28a of the second rotary cutter 20b is a surface rising at an obtuse angle θ1 from a portion of the third surface 24 that does not form the protruding portion 28 and that is in front of the front inclined surface 28a in the rotation direction R2 of the second rotary cutter 20b. The planar surface 28b is a surface coupled to the front inclined surface 28a at an obtuse angle θ2 with the front inclined surface 28a. The rear inclined surface 28c is a surface coupled to the planar surface 28b at an obtuse angle θ2.

The protruding portion 28 has a corner portion 29a between the front inclined surface 28a and the planar surface 28b, and a corner portion 29b between the planar surface 28b and the rear inclined surface 28c. The corner portion 29a is a coupling portion between the front inclined surface 28a and the planar surface 28b, and is a corner portion formed of the front inclined surface 28a and the planar surface 28b. The corner portion 29b is a coupling portion between the planar surface 28b and the rear inclined surface 28c, and is a corner portion formed of the planar surface 28b and the rear inclined surface 28c. The corner portions 29a and 29b are obtuse corner portions. The corner portions 29a and 29b provided on the third surface 24 of the protruding portion 28 have an obtuse angle of 90° or more. The protruding portion 28 does not have any acute corner portions. The shape of the protruding portion 28 is, for example, substantially trapezoid when viewed from the Z-axis direction. The sheet S is bent by the protruding portion 28. No slits are formed in the sheet S by the protruding portion 28. Further, although not illustrated, the corner portions 29a and 29b may be chamfered.

The protruding portion 28 is, for example, provided in a plurality. The plurality of protruding portions 28 of the first rotary cutter 20a are provided at predetermined intervals along the rotation direction R1 of the first rotary cutter 20a. One tearing blade 27 is provided between adjacent ones of the protruding portions 28 in the rotation direction R1. The plurality of protruding portions 28 of the second rotary cutter 20b are provided at predetermined intervals along the rotation direction R2 of the second rotary cutter 20b. One tearing blade 27 is provided between adjacent ones of the protruding portions 28 in the rotation direction R2.

As illustrated in FIGS. 1 and 2, the first spacer 30a is provided on the first rotary shaft member 10a. The first spacer 30a is provided in a plurality. The first spacers 30a are configured so as to not rotate with the first rotary shaft member 10a. The first spacers 30a are each provided with a through hole 31a penetrating in the Z-axis direction, and the first rotary shaft member 10a passes through the through hole 31a. The first spacers 30a are fixed to the fixed frame 2 by rods 6.

The second spacer 30b is provided on the second rotary shaft member 10b. The second spacer 30b is provided in a plurality. The second spacers 30b are configured so as to not rotate with the second rotary shaft member 10b. The second spacers 30b are each provided with a through hole 31b penetrating in the Z-axis direction, and the second rotary shaft member 10b passes through the through hole 31b. The second spacer 30b are fixed to the fixed frame 2 by the rods 6. The material of the spacers 30a and 30b is, for example, a metal.

The first rotary cutters 20a and the first spacers 30a are alternately arranged in the first axis A1 direction. The second rotary cutters 20b and the second spacers 30b are alternately arranged in the first axis A1 direction. The first rotary cutters 20a and the second spacers 30b are disposed so as to face each other in the X-axis direction. In the illustrated example, the second spacer 30b is located away from the first rotary cutter 20a in the +X axis direction. The second rotary cutter 20b and the first spacer 30a are disposed facing each other in the X-axis direction. In the illustrated example, the first spacer 30a is located away from the second rotary cutter 20b in the −X-axis direction.

As viewed from the first axis A1 direction, a portion of the first rotary cutter 20a and a portion of the second rotary cutter overlap each other. In the direction of the first axis A1, a gap G is provided between the first rotary cutter 20a and the second rotary cutter 20b.

The first gap-forming member 40a is provided on the first rotary shaft member 10a. The first gap-forming member 40a is provided in a plurality. The first gap-forming member 40a is located between the first rotary cutter 20a and the first spacer 30a. The first gap-forming member 40a forms the gap G between the first rotary cutter 20a and the first spacer 30a.

The first gap-forming member 40a may rotate with the first rotary shaft member 10a or may not rotate with the first rotary shaft member 10a. The first gap-forming member 40a may be provided integrally with the first rotary cutter 20a, or may be provided integrally with the first spacer 30a.

The second gap-forming member 40b is provided on the second rotary shaft member 10b. The second gap-forming member 40b is provided in a plurality. The second gap-forming member 40b is located between the second rotary cutter 20b and the second spacer 30b. The second gap-forming member 40b forms the gap G between the second rotary cutter 20b and the second spacer 30b.

The second gap-forming member 40b may rotate with the second rotary shaft member 10b or may not rotate with the second rotary shaft member 10b. The second gap-forming member 40b may be provided integrally with the second rotary cutter 20b, or may be provided integrally with the second spacer 30b. The material of the gap-forming members 40a and 40b is, for example, a metal.

### 1.1.2. Action

As illustrated in FIG. 2, when the sheet S is loaded in the −Y axis direction, the sheet S is placed between the first rotary cutter 20a and the second spacer 30b and enters a gap between the second rotary cutter 20b and the first spacer 30a.

The sheet S is slit by the tearing blade 27 of the first rotary cutter 20a while being guided by the front inclined surface 28a of the protruding portion 28 of the second rotary cutter 20b. Specifically, as illustrated in FIG. 1, the tearing blade 27 of a first rotary cutter 20a1 enters a gap between the front inclined surfaces 28a of the protruding portions 28 of second rotary cutters 20b1 and 20b2 adjacent thereto in the Z axis direction, and a slit is formed in the sheet S in the Z axis direction. Because a slit is formed by the tearing blade 27 while the sheet S is pressed by the protruding portions 28 of the second rotary cutters 20b1 and 20b2 that are adjacent thereto, the cut surface formed by the tearing blade 27 is rough. Furthermore, the sheet S is pushed by the protruding portions 28 and ends up having a bent shape.

Similarly, the sheet S is guided by the front inclined surface 28a of the protruding portion 28 of the first rotary cutter 20a, and a slit is formed by the tearing blade 27 of the second rotary cutter 20b.

Next, with the rotation of the rotary cutters 20a and 20b, the sheet S is cut in a direction parallel to the XY plane. Specifically, the sheet S is cut by the corner portions 25 and 26 of the rotary cutters 20a and 20b to form a plurality of small pieces. Here, because a gap G is provided between the first rotary cutter 20a and the second rotary cutter 20b in the Z-axis direction, the cut surface formed by the corner portions 25 and 26 is rough.

As described above, the sheet S is roughly crushed by the crushing apparatus 100 into a plurality of small pieces. The small pieces have a strip shape. The cut surface of the small piece in the transverse direction is formed by the tearing blade 27, and the cut surface of the small piece in the longitudinal direction is formed by the corner portions 25 and 26.

### 1.1.3. Features

The crushing apparatus 100 has, for example, the following features.

In the crushing apparatus 100, a gap G is provided between the first rotary cutter 20a and the second rotary cutter 20b in the first axis A1 direction. Therefore, in the crushing apparatus 100, compared with the case where a first rotary cutter and a second rotary cutter come into contact, the sharpness of the rotary cutters 20a and 20b is poor, and small pieces containing long fibers can be formed. Therefore, when the small pieces formed by the crushing apparatus 100 are used in the paper recycling apparatus, the paper recycling apparatus can produce recycled paper with high paper strength. In addition, for example, in order to increase paper strength, because the amount of binder that binds the fibers to each other can be reduced, the cost can be reduced and the environmental load can be reduced. For example, in the crushing apparatus 100, the longitudinal-direction cut surface of the small piece formed by the rotary cutters 20a and 20b can be roughened and a small piece having a large surface area can be formed.

In the crushing apparatus 100, the third surface 24 forms the protruding portion 28 which protrudes in a direction perpendicular to the first axis A1 direction, and the protruding portion 28 does not have any sharp corner portions. Therefore, in the crushing apparatus 100, a bent piece can be formed by pressing the sheet S with the protruding portion 28.

The first gap-forming member 40a that is provided on the first rotary shaft member 10a and that forms the gap G, and the second gap-forming member 40b that is provided on the second rotary shaft member 10b and that forms the gap G are included in the crushing apparatus 100. Therefore, in the crushing apparatus 100, the size of the gap G can be easily adjusted by the gap-forming members 40a and 40b.

The size of the gap G is preferably 1 mm or more and 5 mm or less. When the size of the gap G is smaller than 1 mm, the sharpness by the first rotary cutter 20a and the second rotary cutter 20b is good, and the roughening of small pieces may be reduced. When the size of the gap G is larger than 5 mm, for example, the pressing force applied to the sheet S by the protruding portion 28 of the second rotary cutter 20b that is adjacent thereto is weakened, and the roughening of the small pieces may be reduced.

### 1.2. Manufacturing Method for Crushing Apparatus

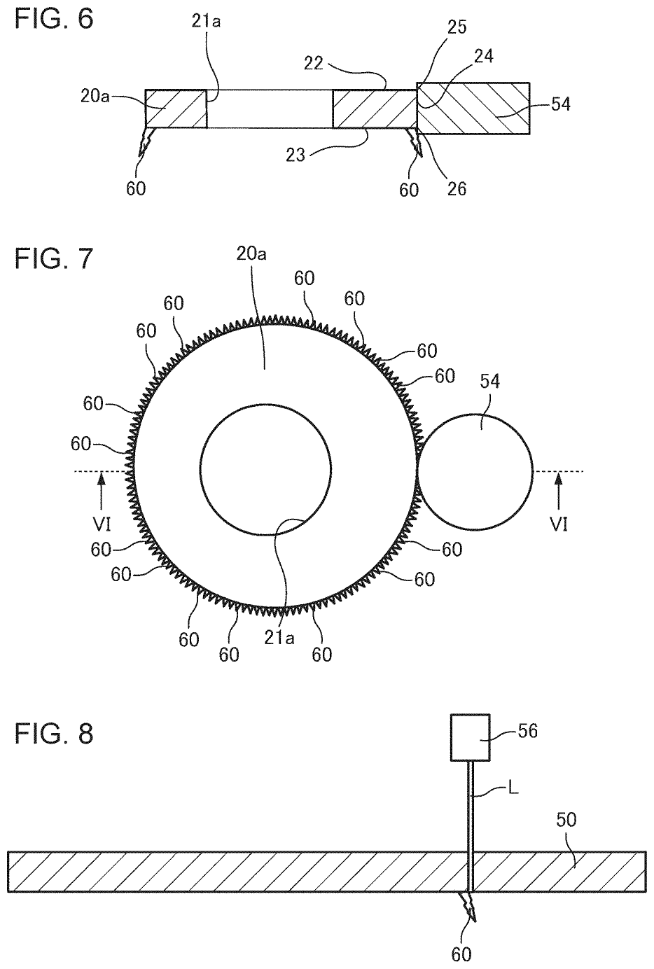

Next, the manufacturing method for the crushing apparatus 100 according to the first embodiment will be described with reference to the drawings. FIGS. 5 and 6 are sectional views schematically illustrating the manufacturing process for the crushing apparatus 100 according to the first embodiment. FIG. 7 is a plan view schematically illustrating the manufacturing process for the crushing apparatus 100 according to the first embodiment. Further, FIG. 6 is a sectional view taken along line VI-VI illustrated in FIG. 7.

As illustrated in FIG. 5, for example, a plate-like member 50 is prepared. Next, the plate-like member 50 is punched into a predetermined shape by a press machine 52. Consequently, the rotary cutters 20a and 20b can be formed.

As illustrated in FIG. 6, burrs 60 are generated in the rotary cutters 20a and 20b processed by the press machine 52. The burrs 60 are generated at the corner portion 26 between the second surface 23 opposite to the first surface 22 pressed by the press machine 52 and the third surface 24. Then, as illustrated in FIGS. 6 and 7, the third surface 24 is polished by a polishing member 54 to remove the burrs 60.

Further, although the burrs may occur also in the corner portion of the inner surface of the through hole 21a and the second surface 23, these burrs are omitted in the example illustrated. In addition, for convenience, FIG. 7 illustrates the first rotary cutter 20a in a simplified manner.

Next, similarly to the rotary cutters 20a and 20b, the spacers 30a and 30b, and the gap-forming members 40a and 40b are formed using a press machine.

Next, as illustrated in FIG. 1, the first rotary cutter 20a, the first spacer 30a, and the first gap-forming member 40a are inserted into the first rotary shaft member 10a, and the second rotary cutter 20b, the second spacer 30b, and the second gap-forming member 40b are inserted into the second rotary shaft member 10b.

The crushing apparatus 100 can be manufactured by the above process.

Further, the rotary cutters 20a and 20b may be processed by a laser element 56 that emits laser light L, as illustrated in FIG. 8, rather than the press machine 52. Even in this case, because the burrs 60 are generated in the rotary cutters 20a and 20b, the burrs 60 are removed by the polishing member 54. The same applies to the spacers 30a and 30b, and the gap-forming members 40a and 40b.

### 2. Second Embodiment

### 2.1. Crushing Apparatus

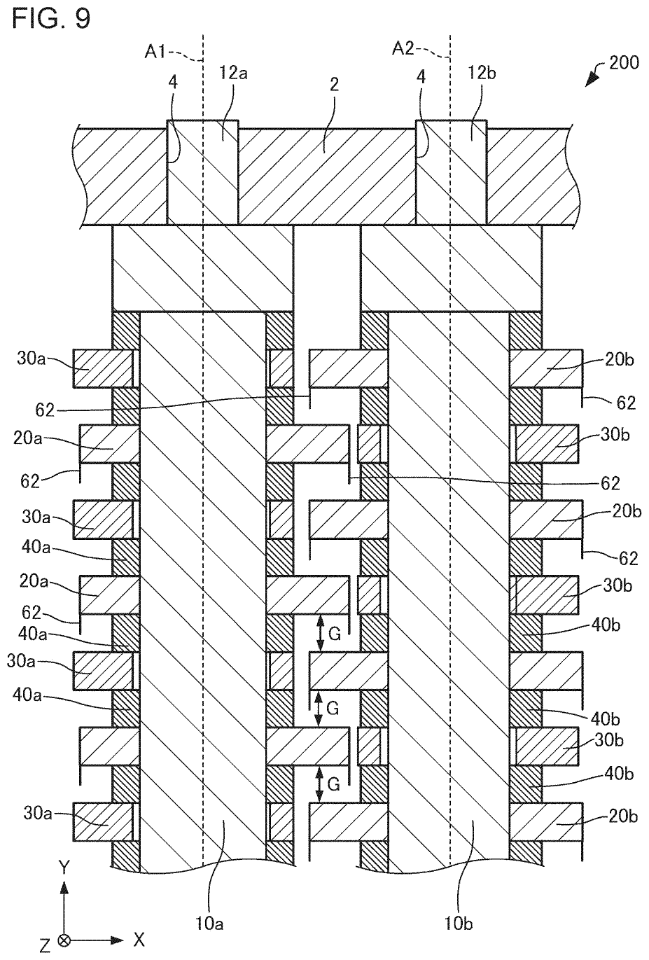

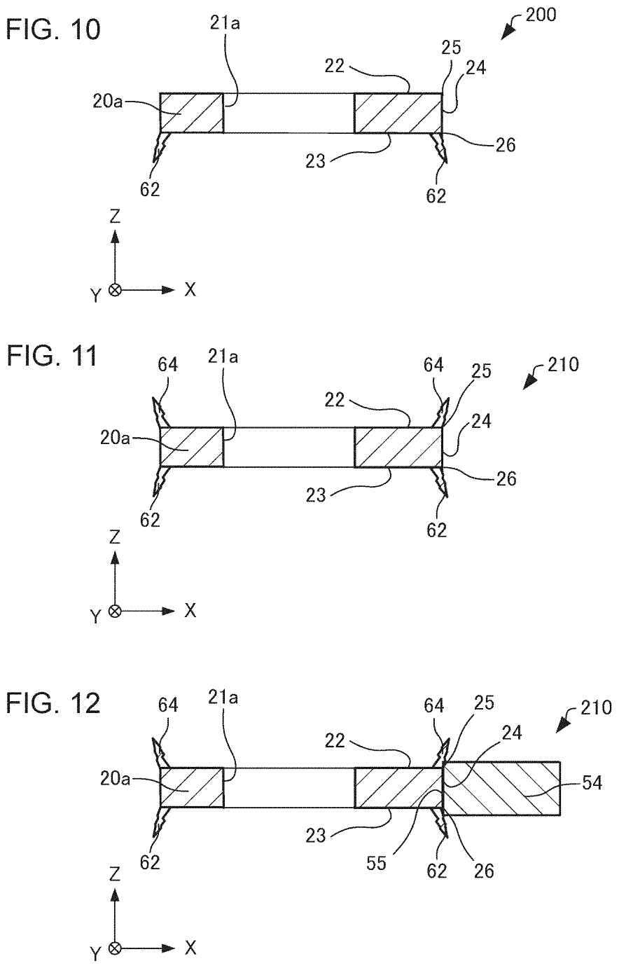

Next, a crushing apparatus according to a second embodiment will be described with reference to the drawings. FIG. 9 is a sectional view schematically illustrating a crushing apparatus 200 according to the second embodiment. FIG. 10 is a sectional view schematically illustrating the first rotary cutter 20a of the crushing apparatus 200 according to the second embodiment. Hereinafter, in the crushing apparatus 200 according to the second embodiment, differences from the example of the crushing apparatus 100 according to the first embodiment mentioned above are described, and description of similar points is omitted.

As illustrated in FIGS. 9 and 10, the crushing apparatus 200 is different from the crushing apparatus 100 described above in that the rotary cutters 20a and 20b have a ripping blade 62. Further, for convenience, FIG. 9 illustrates the ripping blade 62 in a simplified manner.

The ripping blade 62 protrudes from the corner portion 26 in a direction intersecting the second surface 23. The ripping blade 62 protrudes from the corner portion 26 in a direction intersecting the Y-axis direction. In the example illustrated in FIG. 10, the ripping blade 62 protrudes in a direction inclined with respect to the Z-axis direction. The ripping blade 62 may protrude in the Z-axis direction. The ripping blade 62 is not provided at the corner portion 25. The rotary cutters 20a and 20b have the ripping blade 62 between the second surface 23 and the third surface 24.

The ripping blade 62 is, for example, a burr generated when the rotary cutters 20a and 20b are formed. The ripping blade 62 is, for example, provided in a plurality along the entire circumference of the corner portion 26. The size of the gap G is larger than the size of the ripping blades 62 in the first axis A1 direction. Thereby, it is possible to prevent the ripping blades 62 and the spacers 30a and 30b from coming into contact with each other.

In the crushing apparatus 200, since the rotary cutters 20a and 20b have the ripping blades 62 protruding from the corner portion 26 in a direction intersecting the second surface 23, the sharpness is dulled due to the shearing force of the rotary cutters 20a and 20b, and the sheet S can be cut so as to be ripped with the ripping blades 62. Therefore, the cut surface of the small pieces can be roughened more.

### 2.2. Manufacturing Method for Crushing Apparatus

Next, a manufacturing method for the crushing apparatus 200 according to the second embodiment will be described. Hereinafter, in the manufacturing method of the crushing apparatus 200 according to the second embodiment, differences from the example of the manufacturing method of the crushing apparatus 100 according to the first embodiment described above will be described, and description of similar points will be omitted.

In the manufacturing method for the crushing apparatus 100 described above, as illustrated in FIGS. 6 and 7, there is a step of removing the burrs 60 generated in the rotary cutters 20a and 20b.

On the other hand, the manufacturing method of the crushing apparatus 200 does not have the process of removing the burrs that are generated in the rotary cutters 20a and 20b. In the crushing apparatus 200, burrs generated in the rotary cutters 20a and 20b are used as the ripping blades 62. Therefore, in the method of manufacturing the crushing apparatus 200, it is not necessary to have a separate process for forming the ripping blades 62, and the process can be shortened.

### 2. 3. Modification of Crushing Apparatus

Next, a crushing apparatus according to a modification of the second embodiment will be described with reference to the drawings. FIG. 11 is a sectional view schematically illustrating a crushing apparatus 210 according to a modification of the second embodiment. Hereinafter, in the crushing apparatus 210 according to the modification of the second embodiment, differences from the example of the crushing apparatus 200 according to the second embodiment described above will be described, and description of similar points will be omitted.

As illustrated in FIG. 11, the crushing apparatus 210 is different from the crushing apparatus 200 described above in that a ripping blade 64 is provided at the corner portion 25.

The ripping blade 64 protrudes from the corner portion 25 in a direction intersecting the first surface 22. The ripping blade 64 protrudes from the corner portion 25 in a direction intersecting with the Y-axis direction. In the example illustrated in FIG. 11, the ripping blade 64 protrudes in a direction inclined with respect to the Z-axis direction. The ripping blade 64 may protrude in the Z-axis direction.

The ripping blade 64 is, for example, a burr generated when the rotary cutters 20a and 20b are formed. The ripping blade 64 is, for example provided in a plurality along the entire circumference of the corner portion 25. The size of the gap G is larger than the size of the ripping blades 64 in the first axis A1 direction. Thereby, it is possible to prevent the ripping blades 64 and the spacers 30a and 30b from coming into contact with each other.

In the crushing apparatus 200, because the rotary cutters 20a and 20b have the ripping blades 62 and 64, the sharpness of the rotary cutters 20a and 20b is poor, and the sheet S can be cut so as to be ripped by the ripping blades 62 and 64. Therefore, the cut surface of the small pieces can be roughened more.

The ripping blades 64 are formed by, for example, forming the rotary cutters 20a and 20b with a press machine and then polishing the third surface 24 with the polishing member 54 having a rough polishing surface 55 as illustrated in FIG. 12. Further, FIG. 12 is a sectional view schematically illustrating a manufacturing process for the crushing apparatus 210 according to the modification of the second embodiment.

### 3. Examples and Comparative Examples

Hereinafter, the present disclosure will be described more specifically with reference to examples and comparative examples. Further, the present disclosure is not limited to the following examples and comparative examples.

### 3.1. Example 1 and Comparative Example 1

As Example 1, small pieces were formed using a crushing apparatus corresponding to the crushing apparatus 100 illustrated in FIGS. 1 and 2. In the crushing apparatus of Example 1, a gap is provided between the first rotary cutter and the second rotary cutter. In addition, the first rotary cutter and the second rotary cutter have protruding portions.

As Comparative Example 1, small pieces were formed using “specifications: small piece size of 2 mm×23 mm” of a shredder “SECRET P143S” manufactured by Ishizawa Seisakusho Co., Ltd. In the crushing apparatus of Comparative Example 1, the first rotary cutter and the second rotary cutter are in contact with each other. In addition, the first rotary cutter and the second rotary cutter do not have protruding portions.

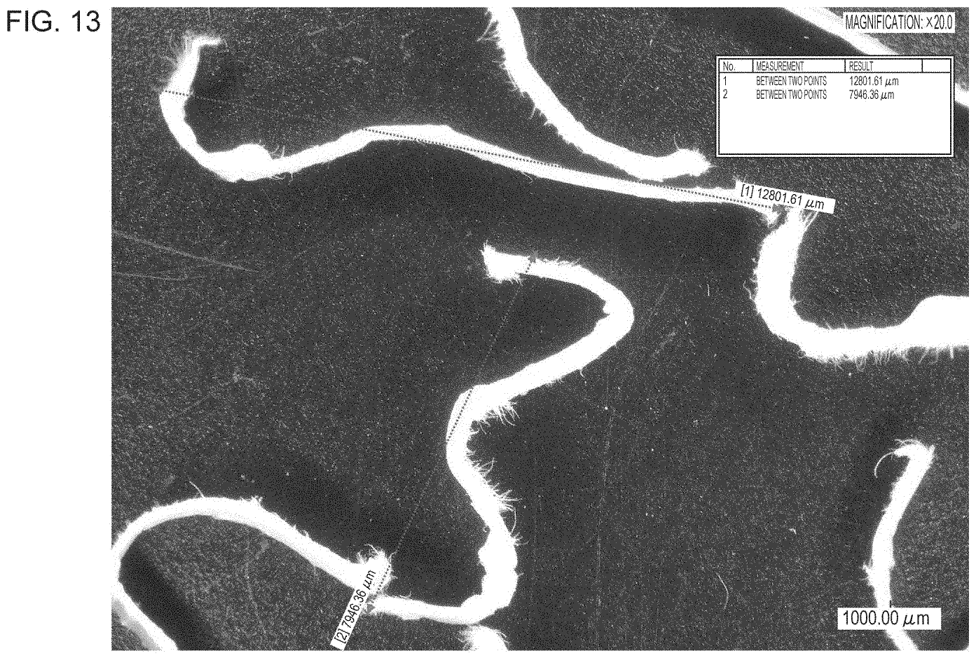

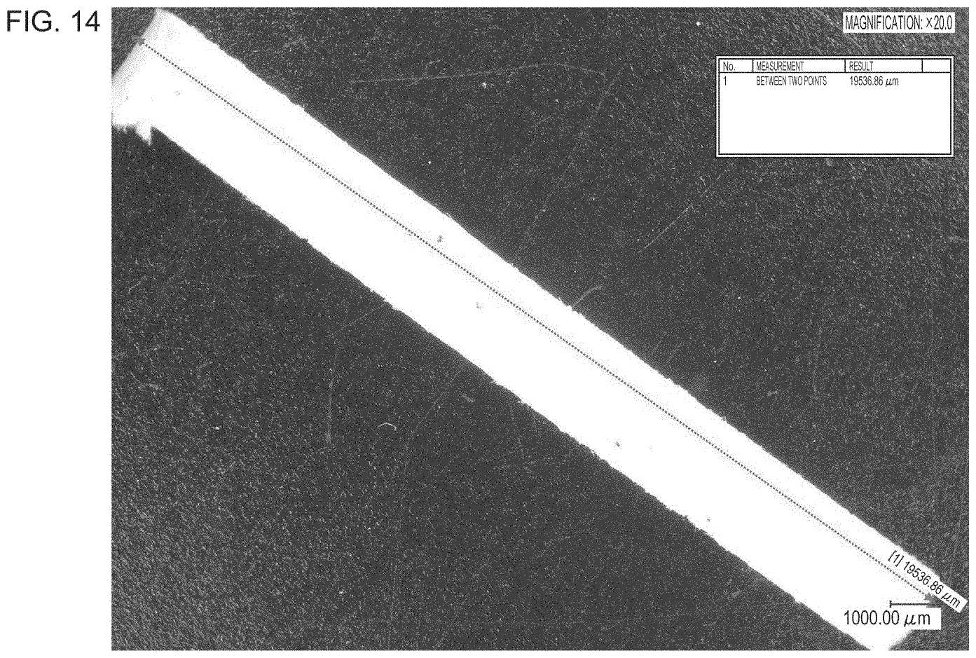

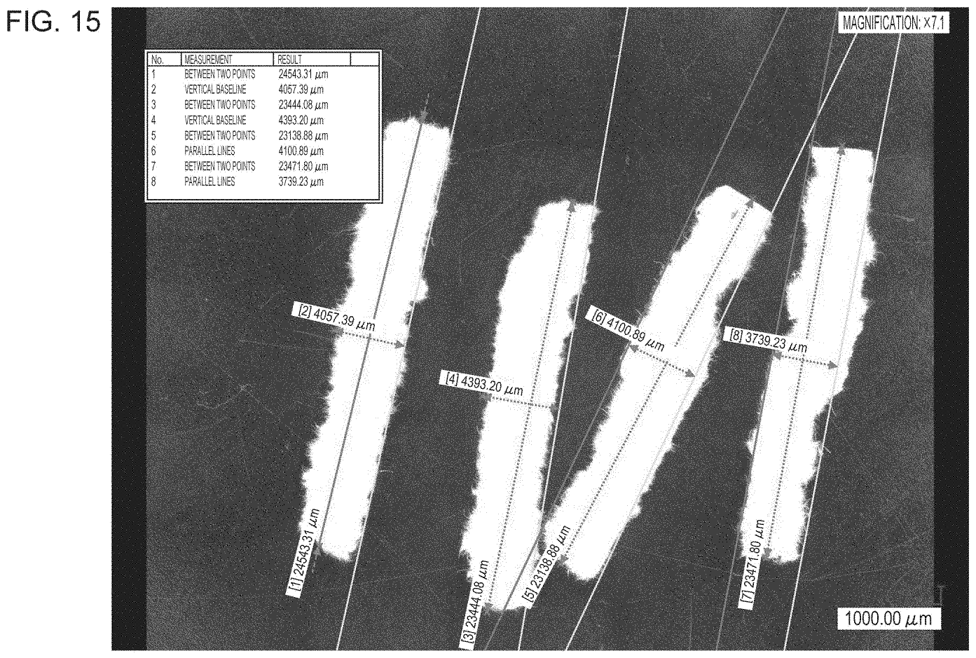

FIG. 13 is a photograph illustrating small pieces of Example 1. FIG. 14 is a photograph illustrating a small piece of Comparative Example 1.

By comparing FIG. 13 with FIG. 14, it was found that with respect to the small pieces of Example 1, both the cut surfaces in the long side direction and the cut surfaces in the short side direction were roughened as compared with Comparative Example 1. This is because in the crushing apparatus of Example 1, a gap is provided between the first rotary cutter and the second rotary cutter. In addition, another reason is that slits were formed in the sheet while being pressed by protruding portions.

### 3.2. Example 2 and Comparative Example 2

As Example 2, small pieces were formed using a crushing apparatus corresponding to the crushing apparatus 100 illustrated in FIGS. 1 and 2. In the crushing apparatus of Example 2, a gap is provided between the first rotary cutter and the second rotary cutter. However, the first rotary cutter and the second rotary cutter do not have protruding portions.

As Comparative Example 2, small pieces were formed using a crushing apparatus similar to the crushing apparatus of Example 2 except that the first rotary cutter and the second rotary cutter were in contact with each other.

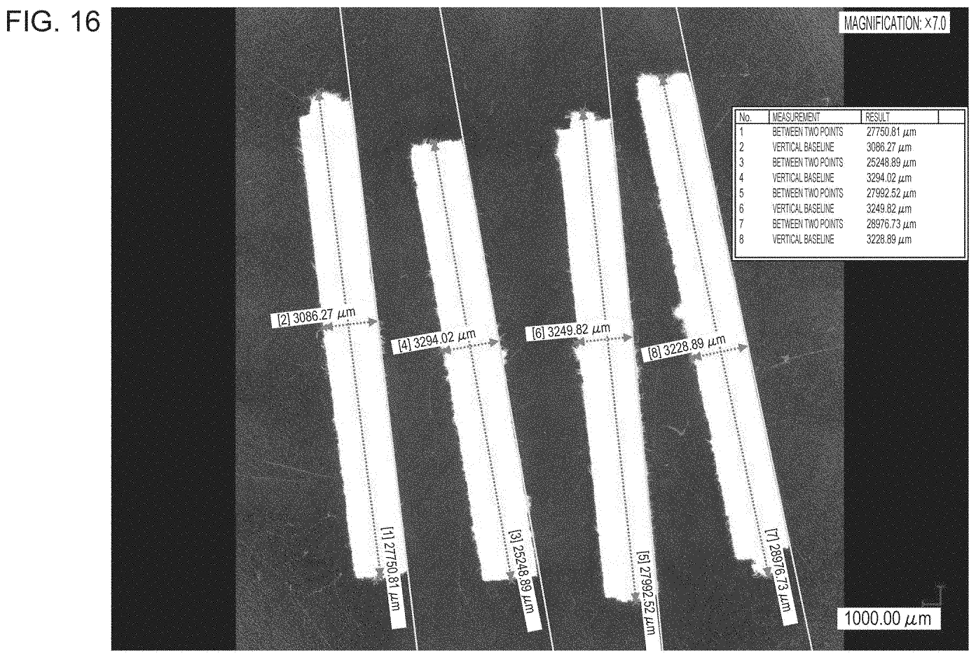

FIG. 15 is a photograph illustrating small pieces of Example 2. FIG. 16 is a photograph illustrating small pieces of Comparative Example 2.

As illustrated in FIG. 15 and FIG. 16, with respect to the small pieces of Example 2, cut surfaces in the long side direction and in the short side direction were found to be rough and uneven as compared with Comparative Example 2.

Next, the fiber lengths of the small pieces of Example 2 and the small pieces of Comparative Example 2 were measured. Small pieces of Example 2 and Comparative Example 2 having a longitudinal-direction size of 25 mm and a transverse-direction size of 3.5 mm were prepared. As the fiber length measuring machine, a fiber tester “CODE912” manufactured by Lorentzen & Wettre Ltd. was used. For the small pieces of Example 2 and Comparative Example 2, 100 ml suspensions each containing 0.1 g of fiber were prepared, and the average fiber length was measured.

The average fiber length of the small pieces of Comparative Example 2 was 0.770 mm, whereas the average fiber length of the small pieces of Example 2 was as long as 0.785 mm. This is because in the crushing apparatus of Example 2, a gap is provided between the first rotary cutter and the second rotary cutter. Further, the fiber length was 0.803 mm when separated into water without making small pieces.

The present disclosure is not limited to the above-described embodiments, and various modifications can be made. For example, the present disclosure includes substantially the same configuration as that described in the embodiments. The substantially same configuration is, for example, a configuration having the same function, method, and result, or a configuration having the same purpose and effect. In addition, the present disclosure includes a configuration in which a non-essential part of the configuration described in the embodiment is replaced. In addition, the present disclosure includes a configuration that achieves the same effect as the configuration described in the embodiment or a configuration that can achieve the same object. In addition, the present disclosure includes a configuration in which known art has been added to the configuration described in the embodiment.

What is claimed is:

1. A crushing apparatus comprising:
a first rotary shaft member that rotates about a first axis;
a second rotary shaft member that rotates about a second axis parallel to the first axis in an opposite direction to a direction in which the first rotary shaft member rotates;
a plurality of first rotary cutters provided on the first rotary shaft member and rotating together with the first rotary shaft member;
a plurality of second rotary cutters provided on the second rotary shaft member and rotating together with the second rotary shaft member;
a plurality of first spacers provided on the first rotary shaft member; and
a plurality of second spacers provided on the second rotary shaft member, wherein
the first rotary cutters and the first spacers are alternately disposed in a first axis direction,
the second rotary cutters and the second spacers are alternately disposed in the first axis direction,
the first rotary cutters and the second rotary cutters each form a tearing blade that protrudes in a direction perpendicular to the first axis direction,
a portion of each of the first rotary cutters and a portion of each of the second rotary cutters overlap when viewed from the first axis direction, and
a gap is provided between the first rotary cutter and the second rotary cutter in the first axis direction.

2. The crushing apparatus according to claim 1, wherein
the first rotary cutter and the second rotary cutter each include
a first surface and a second surface that are perpendicular to the first axis direction,
a third surface formed in a thickness direction of the first rotary cutter and the second rotary cutter, the tearing blade being provided on the third surface, and
a ripping blade protruding in a direction intersecting the second surface between the second surface and the third surface, and
a size of the gap is larger than a size of the ripping blade in the first axis direction.

3. The crushing apparatus according to claim 2, wherein
the third surface includes a protruding portion protruding in the direction perpendicular to the first axis direction, and
a corner portion of the protruding portion provided on the third surface has an obtuse angle of 90° or more, or the corner portion is chamfered.

4. The crushing apparatus according to claim 1, further comprising:
a first gap-forming member provided on the first rotary shaft member and forming the gap; and
a second gap-forming member provided on the second rotary shaft member and forming the gap.
